(19) United States
(12) Patent Application Publication
(10) Pub. No.: US 2005/0024181 A1
(43) Pub. Date: Feb. 3, 2005

(54) Method and security apparatus for validating an authorization for locking and unlocking and/or using an object

(75) Inventors: Klaus Hofbeck, Neumarkt (DE); Wolfgang Piesch, Regenstauf (DE); Birgit Rosel, Regensburg (DE); Michael Stippler, Schwandorf (DE)

Correspondence Address: Andreas Grubert;Baker Botts L.L.P., 910 Louisiana, One Shell Plaza, Houston, TX, 77002-4995, US

(73) Assignee: Siemens Aktiengesellschaft

(21) Appl. No.: 10/902,529

(22) Filed: Jul. 29, 2004

(30) Foreign Application Priority Data
Jul. 29, 2003 (DE) DE10334625.2

(51) Int. Cl. H04Q 1/00

(52) U.S. Cl. 340/5.7

(57) ABSTRACT

A known PASE system is significantly improved by the addition of a LF field, which is restricted to the interior of the motor vehicle, for the purpose of achieving highly reliable differentiation between the inside and outside of the motor vehicle. A LF signal in this field, in the form of a LF ping, is used as a control signal with the function of differentiating between the area inside and outside the motor vehicle and for awakening or activating a semi-active identification transmitter CID. In preferred embodiments, the LF ping itself is preferably not used for data transmission, which continues to be handled in the GHz band, so that the system as a whole also operates very rapidly.

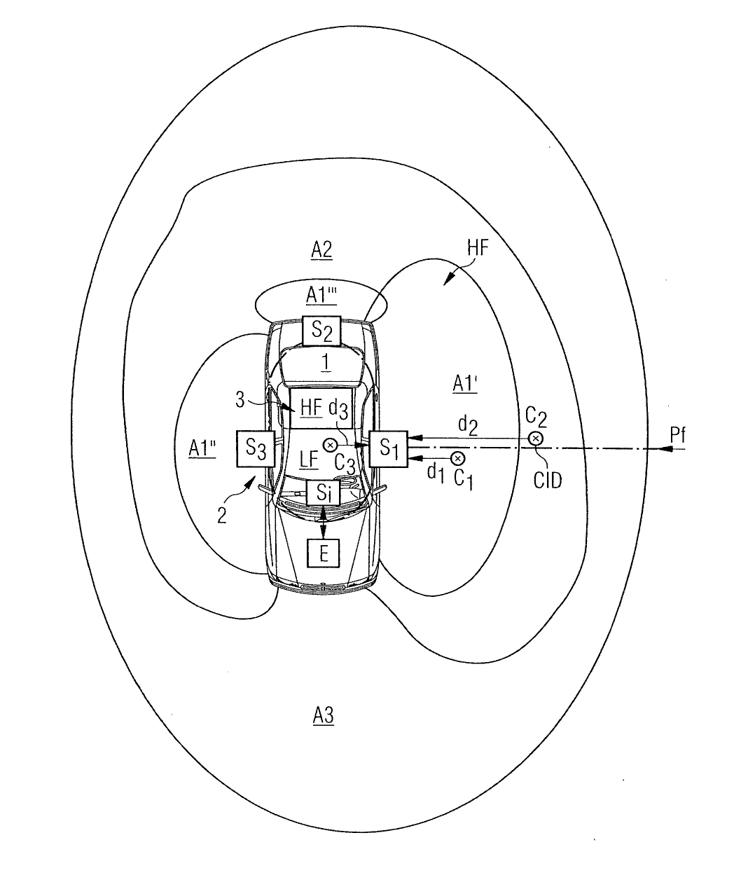

### PRIORITY

This application claims priority to German application no. 103 34 625.2 filed Jul. 29, 2003.

### TECHNICAL FIELD OF THE INVENTION

The present invention relates to a method for validating an authorization for locking and unlocking and/or using an object, such as a motor vehicle in particular, and a security apparatus. Without restricting the invention, fields of application in the area of home security or the prison system, etc., are not described in further detail below, since motor vehicles here represent the greatest demand for a security apparatus of this type and a corresponding method. Without dispensing with other areas of application that have similar requirements, motor vehicles are regarded as being the main area of application for this invention.

### DESCRIPTION OF THE RELATED ART

A method of this type is disclosed in the German patent document DE 199 12 319 C1, for example. In a security apparatus in accordance with the teaching of the cited patent document, a control device is arranged in the object, said control device being connected to a transmitter and receiver unit. When initiated by the control device, the transmitter and receiver unit sends out a request signal. If an identification transmitter receives this request signal, it in turn sends back a reply signal, which is received by the transmitter and receiver unit then analyzed by the control device. In the framework of this analysis, an authorization of a person carrying the relevant identification transmitter is checked, an example of said authorization being to open the doors of a relevant motor vehicle. Furthermore, if an authorization is present and confirmed, the control device activates at least one locking control means in the motor vehicle, depending on a relevant distance of the code generator from the motor vehicle and depending on a location in a relevant detection zone around the motor vehicle. In particular, no additional deliberate action is required on the part of the user in order to unlock or open a motor vehicle door, for example. Accordingly, such a system is also known as a passive start and entry system.

Furthermore, as described in the German patent document DE 100 64 141.5 A1, following a confirmation of authority or authorization, further different control commands are initiated by means of the control device by an authorized user, the intention being to increase the user friendliness, depending on a relevant position of the identification transmitter in relation to the object.

Reference is made to distance measurement in anti-theft devices, as disclosed, for example, in DE 199 57 536 A1.

A passive access and start control method is known from DE 199 01 364 A1, whereby a code is automatically transferred as the second signal within a defined external area following a request by a “wake-up” signal emitted as the first signal. The “wake-up” signal switches the portable identification transmitter from energy-saving mode to an active transmitting and receiving status. The emission of the wake-up signal is controlled via approximation devices and/or sensors. According to this disclosure, the differentiation of the area inside and outside the motor vehicle is carried out using specially formed microwave fields outside the motor vehicle with the help of additional sensors. This function, which is essential for ensuring the operation and reliability of a passive start and entry system, is implemented by the generation of first and second signals and by the corresponding evaluations, which may involve a high level of additional outlay in terms of technology.

### SUMMARY OF THE INVENTION

The object of the present invention is therefore to address the problem of developing a method and a security apparatus of the type cited above, and thereby improving the reliability of a relevant distance measurement.

This object can be achieved in accordance with the invention by a method for validating an authorization for locking and unlocking and/or using an object, comprising the steps of:
transmitting a request signal by at least one transmitter and receiver unit, and, if a movable and, in particular, a portable identification transmitter receives this request signal, sending back a response signal by said identification transmitter,
evaluating the response signal after being received in the transmitter and receiver unit, and
if authorization for the identification transmitter is present and detected, issuing at least one control command in the object by the control unit, wherein an additional signal is emitted, said additional signal being restricted to the interior of the object.

The object can furthermore be achieved by a security apparatus for validating an authorization for locking and unlocking and/or using an object, comprising means for transmitting a request signal by at least one transmitter and receiver unit, and, means for sending back a response signal by said identification transmitter, means for evaluating the response signal after being received in the transmitter and receiver unit, and means for issuing at least one control command in the object by the control unit if authorization for the identification transmitter is present and detected, wherein an additional signal is emitted, said additional signal being restricted to the interior of the object.

The object may be a motor vehicle. The apparatus may comprise a control unit disposed in the object, said control unit being connected to at least one transmitter and receiver unit, such that the transmitter and receiver unit is designed to emit a request signal when triggered by the control unit, and, if an authorization is present and detected, depending on the distance of the identification transmitter from the object and its localization in a particular detection zone around the object, the control unit is designed to emit at least one control command in the object.

In order to provide a reliable means of distinguishing between the inside and the outside of the motor vehicle, an additional signal is emitted, said signal being limited to the interior (3) of the motor vehicle. This signal may therefore only be received inside the motor vehicle by the identification transmitter or key. Preferably, an electromagnetic wave in a low-frequency, inductive LF band, preferably in the kHz band, is emitted inside the motor vehicle or in the passenger compartment. The LF wave differs crucially from the high-frequency and maximum frequency waves used inside and outside the motor vehicle for measuring distance and checking authorization, by virtue of its physical characteristics: the screening provided by the metallic bodywork of the motor vehicle and the essentially cubic reduction in transmission power over the distance from a particular transmission antenna creates a roughly radially symmetrical field, which covers only the interior of the motor vehicle. The LF wave can therefore only be received inside the motor vehicle and is therefore a highly reliable indicator of the presence of the key within the motor vehicle, since it cannot be received by the key outside the passenger compartment. Thus the presence of the key or other identification transmitter inside a particular motor vehicle may be ascertained with a high degree of reliability yet with little outlay in terms of technology, for example from the key's response to the LF wave.

In one embodiment of the invention, the identification transmitter CID is designed as a modulating backscattering device which preferably has at least two operating statuses. It receives high-frequency energy radiated from a transmitter and receiver unit in the motor vehicle and backscatters the energy together with information. In addition, the identification transmitter is switched to and fro between a passive first status and a semi-active or active second status, in order to reduce the energy requirement. This helps to prolong the life of the battery in the identification transmitter.

It is advantageous for only the LF wave to be used as the localization signal, in order to cause the identification transmitter to switch over from a passive to an active status. In an active status, each maximum level for an access or start authorization is checked, so that—for example—a motor vehicle is only then actually released for the purpose of unlocking a steering lock, or starting the engine, etc.

It is advantageous for a localization signal designed for this purpose to be emitted in the form of a simple “wake-up” pattern, known as a LF ping, preferably with a length of 2 bytes. This LF ping is used only for awakening or activating the identification transmitter. It therefore does not need to incorporate an actual authentication check, and the signal can thus be kept as simple as possible. The LF ping only needs to be differentiated from noise signals inside the motor vehicle. In a preferred embodiment, the LF ping has no other tasks apart from the function of awakening or activating the identification transmitter. In particular, it does not need to be evaluated with regard to its data content, or retransmitted. The simple structure of the LF ping thus guarantees prompt transmission and sufficiently rapid response in the overall system, even at a low frequency of—for example—125 kHz.

An almost entirely magnetic field with greatly reduced distance is emitted at a LF frequency within a band of approximately 125 kHz. Thus a circular wave field approximately 2 m in diameter is formed around a LF antenna. This circle is restricted to the area inside the motor vehicle, i.e. within the passenger compartment, since it is screened from the exterior by the metallic bodywork. Thus only one or possibly two LF antennas are required inside the motor vehicle. These may be applied with comparatively little cost, so that they cover only the interior of the motor vehicle. Thus the main criterion for reliable differentiation between the inside and outside of the motor vehicle, according to which the range of the LF antennas may not extend outside the motor vehicle, is fulfilled without the use of costly switches or complicated algorithms. In addition, an output stage, with a high output of approximately 30 W, is not required with this short range within the LF band.

The LF antennas should preferably be located in a central area of the motor vehicle, in accordance with the requirement that they should only cover the area inside the motor vehicle. A suitable location might be on the central console in the area between the front seats, or in the center of the back seat. They should ideally be located at floor level, in order to derive maximum benefit from the additional screening effect of the metal chassis from the exterior of the motor vehicle with reference to the LF wave.

To reduce power consumption even further, a LF transmitter is activated in order to emit the LF ping only if an identification transmitter is located near the motor vehicle, and there is a need to differentiate between the inside and outside of the motor vehicle. This is the case, for example, if a door contact is actuated. It is advantageous for such localization to be done on the basis of an existing system, which, in one embodiment, provides a zone model with localization and distance measurement in the area outside the motor vehicle.

Furthermore, a LF transmitter for emitting the LF ping can also be activated if actively triggered by the user, for example on a door handle. Furthermore, the LF ping is emitted if a start/stop button or a door contact is actuated. If the motor vehicle is locked, a LF ping is not emitted.

By using and incorporating the functionality of a GHz passive start and entry system disclosed by the applicant in previous applications, including for the purpose of detecting an approach to the motor vehicle, all the advantages of the said system may be exploited in full without significant additional cost. Because of the relatively large distance over which the approach of the identification transmitter can be detected by distance measurement in the GHz band, the operating cycle or loading phase—known technically as the duty cycle—can be greatly decreased in comparison to known systems. Accordingly, a LF receiver in the identification transmitter might also only be activated if a request for it is made via a communication channel. The actuation of a door contact may be used as the trigger for such a request to the identification transmitter. This has the beneficial side-effect of significantly prolonging the service life of the battery in the identification transmitter.

On the other hand, now that the operating cycle of the system according to the invention is shorter, the response time inside the motor vehicle may be too short to guarantee normal, rapid engine start-up. If a LF ping is used according to the invention, the identification transmitter is awakened with this LF ping, the requests are clocked accordingly in the operating cycle, and normal, rapid engine start-up is also guaranteed using this energy-saving method.

In addition, in one embodiment of the invention in a system of this type, extensive use is made of hierarchical security structures, such that—when the identification transmitter approaches the motor vehicle—graduated security and authentication requests are exchanged. For this purpose, in particular, the area outside the particular motor vehicle may be designed according to a zone model with distance measurement and/or localization of a portable identification transmitter. The motor vehicle, with its transmitter and receiver unit, is at the center of this area. In a preferred embodiment, localization of the identification transmitter, in particular by assigning it to the area to the right, left, or rear of the motor vehicle, is done solely within the GHz frequency band.

Thus a method and a system for differentiating between the inside and outside of a motor vehicle, with developments, have been described above, said method and system being capable of interoperating in modular fashion with a passive start and entry system with external localization and communication in the GHz frequency band. In addition to the area outside the motor vehicle, the area inside the motor vehicle is also covered by electromagnetic waves in the GHz band, so that the advantages of efficient and rapid localization and prompt communication for the purpose of checking access authorization are retained. According to the invention, a LF signal is used only as the control signal with the function of differentiating between the inside and outside of a motor vehicle, and possibly for awakening or activating the portable identification transmitter. The LF ping itself is therefore preferably not used for data communication, so that the system as a whole operates very reliably and rapidly. Thus all the advantages of methods and devices that have been disclosed for passive access control and start systems, including by the applicant in previous applications, in particular reliable relay-attack protection and pretriggering, can also be fully exploited as part of a system configured and/or extended according to the invention.

Other advantageous embodiments of the invention are explained in the subclaims.

### BRIEF DESCRIPTION OF THE DRAWING

The present invention is explained in greater detail in order to illustrate further features and advantages of an apparatus according to the invention for implementing a method described above, with reference to the attached drawing, on the basis of a preferred exemplary embodiment. The single diagram illustrates schematically the top view of a motor vehicle in a zone model.

### DETAILED DESCRIPTION OF THE PREFERRED EMBODIMENTS

One method for validating an authorization for locking and unlocking and/or using an object is explained in greater detail below on the basis of an example of a security apparatus 2 for protecting against unauthorized entry or use, said security apparatus being shown in a motor vehicle 1. A security apparatus 2 is provided in the motor vehicle 1, said security apparatus comprising a control unit E, and—in this instance—four transmitter and receiver units Sᵢ, S₁ to S₃. The control unit E activates the four transmitter and receiver units Sᵢ, S₁, S₂ and S₃ for the purpose of transmitting a request signal, and receives a response signal if an identification transmitter CID is nearby and can be reached by the request signal.

The transmitter and receiver units Sᵢ to S₃ cover three essentially different close-range sectors A1′ to A1′″, located at the sides and in the area around the trunk of the motor vehicle 1. These sectors are adjoined, at a greater distance around the motor vehicle, by a positional zone A2 and, finally, by an outer zone A3. Each of the said positional zones is assigned a specific function by the control unit E depending on the distance d from the motor vehicle.

When the overall system is idle, the apparatus 2 emits request signals at intervals. The transmission frequency of these signals is significantly increased when a response signal is received from an identification transmitter CID. If a person now moves along the dotted line shown on the diagram toward the driver's door of the motor vehicle 1 in the direction of the arrow Pf, then the security apparatus 2 must reliably differentiate, via the transmitter and receiver unit S₁, between the location of an identification transmitter CID in a position C₂ and the location of the identification transmitter CID in a position C₁, on the basis of the distance d₁ or d₂, so that the function of the positional zone A1′ can now also be executed reliably in the position C₁ by the control unit E on the basis of a previously executed function that belongs to the positional zone A2, in order to increase operating convenience of the motor vehicle 1. For potential function ranges and advantages for protecting a motor vehicle 1 against theft, etc., full reference is made to the disclosure of DE 100 64 141.5.

On the basis of the zone model of the GHz PASE (Passive Start and Entry) system disclosed in DE 100 64 141.5, as an access control system by the applicant, in which—compared to a known method of remote radio operation—no additional active operation is required, each of the zones illustrated in the diagram is assigned a distance-specific function. As an example of function assignment, three zones are assumed and are situated along the dotted line in the direction of the arrow Pf. In this case the outer zone A3 controls the headlamps of the motor vehicle 1, the midway zone A2 activates the interior lighting, and the inner zone A1′ is allocated to the actual unlocking of the motor vehicle. Using distance measurement, the position of the code signal generator CID (=Customer Identification Device) is ascertained on the basis of HF electromagnetic waves to provide a new type of key for a passive access start and entry system (PASE system), which must be carried in order to prove an access authorization, without the need to press a button on the code signal generator CID, e.g. to access, start or lock the motor vehicle. A particular distance is then assigned to a corresponding zone, whereupon the function prescribed for the said zone is triggered by the control unit S.

When a code signal generator approaches the motor vehicle, as illustrated in this example by positions C₁ and C₂, it is now expected that these functions will be activated or deactivated once in the defined sequence. If there is significant variation in the distance measurement, this may cause the code signal generator to be assigned to the wrong zone, which—in turn—would trigger an incorrect function. For example, the headlamps might be switched on and off, even though the code signal generator remains located in the outer zone A3. However, reflections and undetected errors in data evaluation may cause the distances measured to vary by several meters, even if—for example—the distance between the transmitter and receiver unit SI and the code signal generator CID is 1.5 m. Internal security and analysis processes prevent incorrect allocation caused by wide variations in measurements taken in direct succession, for example by evaluating the reliability of the measurement results. Frequent activation, locking and unlocking, etc. is thus ruled out, and the position C₁ or C₁ is reliably detected. The approach of the identification transmitter CID is therefore reliably detected by distance measurement. Furthermore, the localization of the identification transmitter CID by assigning it to the area to the right, left, or rear of the motor vehicle 1, is done solely in the GHz frequency band via by a wave field HF. In addition, the identification transmitter CID is designed as a modulating backscattering device in this exemplary embodiment; it therefore receives the high-frequency energy radiated to it and backscatters it together with information. In addition, the identification transmitter CID can be switched to and fro between a passive and a semi-active status, in response to an external request, in order to reduce its own energy requirement. This helps to prolong the service life of the battery accordingly.

A user now accesses the interior 3 of the motor vehicle 1 using the identification transmitter CID as a key. The key CID is located at a point C₃ at a distance d₃ from the sensor S₁, which roughly corresponds to the distance d₁ from the position C₁ defined by the sensor S₁. However, no further information in addition to the determination of these distances can be ascertained by distance measurement. Simple distance measurement, therefore, cannot tell that C₁ is outside the motor vehicle, whilst C₃ is on the interior 3 of the motor vehicle. In particular, this distance measurement is also unable to tell that the key CID is now located on the interior 3 of the motor vehicle 1.

What is required is for an authorized user to be able to use and start the motor vehicle 1 immediately in a passive start and entry system, without significant delay, provided that he or she is on the interior 3 of the motor vehicle and sitting in the driver's seat. Otherwise, on the basis of simple distance measurement as described above, it might be possible for a child—for example—to start the motor vehicle without authorization while the user is still outside it. For safety reasons, safeguards against such incidents must also feature in future systems in which ignition keys in their current form, which must be inserted into an ignition lock in order to unlock the steering wheel and start the engine, will no longer exist.

To obtain reliable distance measurement with differentiation between the inside and outside of the motor vehicle as the trigger for further actions, the system of HF communication and localization described above is extended by the addition of an indicator for reliable localization on the interior 3 of the motor vehicle. For this purpose, using a method not described in greater detail, the transmission of a field of LF waves in a frequency band of 125 kHz is actuated by the control unit E. On the interior 3 of the motor vehicle—in addition to the base station for the GHz frequency band—there is a LF output stage which transmits on 125 kHz at low power. Two LF antennas are provided inside the motor vehicle. These can be applied with comparatively little cost, so that they cover only the interior of the motor vehicle. Accordingly, the ranges of the LF antennas must not extend outside the motor vehicle. At 125 kHz, however, an almost entirely magnetic field with greatly reduced distance is emitted. There is a cubic reduction in transmission power in LF wave fields over the distance r as the distance to a transmitter, whilst at high frequency HF this reduction in power only runs with 1/r. In total, a circle of approximately 2 m in diameter is formed around an LF antenna, which remains restricted within the passenger compartment on the interior 3 of the motor vehicle, since—due to the predominantly magnetic properties of the LF waves—it is screened from the exterior by the metallic bodywork. In addition, because of the requirement that they should cover only the interior of the motor vehicle, the LF antennas are to be located in a central area of the motor vehicle, i.e. in the central console between the front seats, and in the center of the back seat at floor level, in order to derive maximum benefit from the additional screening effect of the metal chassis from the exterior of the motor vehicle with reference to the LF wave.

This ensures that a LF signal from an appropriately equipped key CID may only be received if the key is located on the interior 3 of the motor vehicle 1. A reliable differentiation between the inside and outside of the motor vehicle is carried out on the basis of the response from the key CID that is triggered by the receipt of the signal.

In a preferred method, however, the LF field has a more extensive use: a LF output stage according to the invention transmits a special, single “wake-up” pattern, known as the LF ping. The LF ping is only 2 bytes in length, and is transmitted whenever an identification transmitter CID is near the motor vehicle or if it is actively triggered by the user, e.g. on the door handle. Furthermore, the LF ping is emitted if a start/stop key is pressed or a door contact is actuated, or if a locking signal is transmitted. If the motor vehicle 1 is locked, a LF ping is not transmitted. If the identification transmitter CID receives the LF ping, then said identification transmitter CID must be on the interior 3 of the motor vehicle. Thus simple differentiation between the inside and outside of the motor vehicle is possible, whereby the designation LF ping also indicates the task whereby the key CID is switched over from a passive to a semi-active status by the LF ping. For security-related actions, such as—for example—releasing the steering lock and starting the motor vehicle engine, a maximum security level with separate code interrogation is also switched over, provided that the identification transmitter CID, and therefore an authorized user, is also on the interior 3 of the motor vehicle on the driver's seat in the optimum monitoring position.

By using the functions of the GHz-PASE system for the purpose of detecting an approach to the motor vehicle, all the benefits of this system are used, in particular reliable relay-attack protection and pretriggering. By means of at least one LF antenna inside the motor vehicle, it is possible to differentiate precisely between the inside and outside of the motor vehicle. In addition, an emergency function of the key CID may be implemented more easily in the LF band than in the GHz band, since—if the batteries in the key CID are exhausted or are too weak—the LF transponder functions in the low-frequency, and—above all—magnetic field, as a coil for supplying power to the key CID.

The advantages of the technical features of the solution proposed above are that—thanks to the relatively large distance over which the approach of the identification transmitter is detected by distance measurement in the GHz band—the operating cycle or duty cycle of the identification transmitter compared to known PASE systems can be greatly reduced. This has the beneficial side-effect of prolonging the service life of the battery in the identification transmitter. On the other hand, due to the short duty cycle, the response time inside the motor vehicle is now too short to guarantee normal engine start-up. If the LF ping is used the identification transmitter is awakened with the LF ping and normal rapid engine start-up is guaranteed.

The LF signal is used in the form of the LF ping only as a control signal with the function of differentiating between the inside and outside of the motor vehicle and for awakening or activating the identification transmitter. In a preferred embodiment the LF ping itself is not used for data communication, so that the system as a whole also operates very rapidly.

A security apparatus has thus been described above that can also be retrofitted in existing systems in order to implement a method according to the invention, said apparatus ideally being significantly improved by the addition of a limited LF field inside the motor vehicle for the purpose of achieving highly reliable differentiation between the inside and outside of the motor vehicle. The continued coverage of the interior with GHz guarantees efficient and rapid localization and communication for the purpose of checking access authorization. The costs for additional hardware are thus essentially limited to the control unit E and at least one additional—but highly cost-effective—LF antenna.

1. A method for validating an authorization for locking and unlocking and/or using an object, comprising the steps of:
transmitting a request signal by at least one transmitter and receiver unit, and, if a movable and, in particular, a portable identification transmitter receives this request signal, sending back a response signal by said identification transmitter,
evaluating the response signal after being received in the transmitter and receiver unit, and
if authorization for the identification transmitter is present and detected, issuing at least one control command in the object by the control unit, wherein an additional signal is emitted, said additional signal being restricted to the interior of the object.

2. The method according to claim 1, wherein the object is a motor vehicle.

3. The method according to claim 1, wherein a LF signal is emitted as an additional signal, preferably only inside the motor vehicle and particularly in a frequency band of approximately 125 kHz.

4. The method according to claim 1, wherein the additional signal is emitted in the form of a LF ping which—in particular—has a simple structure.

5. The method according to claim 1, wherein the LF ping is emitted with a length of at least 2 bits.

6. The method according to claim 1, wherein the identification transmitter is switched to an active status for the purpose of localization and/or communication before it reaches the interior of the motor vehicle, preferably at all times.

7. The method according to claim 1, wherein the identification transmitter is switched to an active status by a localization signal, which is only received inside the motor vehicle by the identification transmitter, whereby a rapid exchange of communication data is carried out between the identification transmitter and the transmitter and receiver unit, preferably in the GHz band.

8. The method according to claim 11, wherein the LF ping is emitted as the localization signal.

9. The method according to claim 11, wherein a LF transmitter is activated in order to transmit the localization signal when the identification transmitter is located near the motor vehicle in an outer zone and/or is actively triggered by the user, in particular by actuating a door handle or by transmitting a locking signal.

10. The method according to claim 1, wherein the localization signal is emitted when a start/stop button or a door contact is actuated or a locking signal is emitted.

11. The method according to claim 1, wherein a localization signal is not emitted if the motor vehicle is locked.

12. A security apparatus for validating an authorization for locking and unlocking and/or using an object, comprising:
means for transmitting a request signal by at least one transmitter and receiver unit, and, means for sending back a response signal by said identification transmitter,
means for evaluating the response signal after being received in the transmitter and receiver unit, and
means for issuing at least one control command in the object by the control unit if authorization for the identification transmitter is present and detected, wherein an additional signal is emitted, said additional signal being restricted to the interior of the object.

13. The security apparatus according to claim 12, wherein the object is a motor vehicle.

14. The security apparatus according to claim 12, wherein a control unit is disposed in the object, said control unit being connected to at least one transmitter and receiver unit, such that the transmitter and receiver unit is designed to emit a request signal when triggered by the control unit, and, if an authorization is present and detected, depending on the distance of the identification transmitter from the object and its localization in a particular detection zone around the object, the control unit is designed to emit at least one control command in the object.

15. The security apparatus according to claim 14, wherein the apparatus is a semi-active backscattering device.

16. The security apparatus according to claim 14, wherein the identification transmitter can be switched from a passive status to an active or semi-active status, in particular by a localization signal from the control unit.

17. The security apparatus according to claim 14, wherein, compared to known systems, the additional hardware required consists essentially of the control unit and at least one LF antenna connected to it.

18. The security apparatus according to claim 14, wherein the object is a motor vehicle and the at least one LF antenna is arranged in a central area of the motor vehicle, e.g. in the central console between the front seats or in the center of the back seat and preferably at floor level.
